(19) United States
(12) Patent Application Publication
(10) Pub. No.: US 2016/0370527 A1
(43) Pub. Date: Dec. 22, 2016

(54) SURFACE LIGHT SOURCE MODULE

(71) Applicant: Young Lighting Technology Inc., Hsin-Chu (TW)

(72) Inventors: Jung-Wei Chang, Hsin-Chu (TW); Yi-Yu Tsai, Hsin-Chu (TW); Hsin-Hung Lee, Hsin-Chu (TW); Chiao-Chih Yang, Hsin-Chu (TW)

(21) Appl. No.: 15/099,953

(22) Filed: Apr. 15, 2016

(30) Foreign Application Priority Data
Jun. 17, 2015 (TW) 104119626

(51) Int. Cl. F21V 8/00

(52) U.S. Cl. CPC G02B 6/005; G02B 6/0055; G02B 6/0068

(57) ABSTRACT

A surface light source module includes a light guiding plate having a light incidence surface and a bottom surface adjacent to the light incidence surface; a reflective sheet disposed on the bottom surface; an adhesive adhered between the bottom surface and the reflective sheet; and a light emitting assembly disposed alongside of the light incident surface. The refractive indices of the adhesive and the light guiding plate are N1 and N2, wherein 63%≦N1/N2≦95%. The light emitting assembly includes a plurality of light emitting elements, of which the distribution curve of luminous intensity satisfies the following conditions: (1) an absolute value of distribution angle at 50% of luminous intensity is smaller than or equal to 55°; and (2) a sum of luminous energy at the absolute value of distribution angle of greater than 70° is smaller than or equal to 10% of a total lumen of the light emitting element.

### FIELD OF THE INVENTION

The invention relates to a light source, and more particularly to a surface light source module.

### BACKGROUND OF THE INVENTION

A liquid crystal display (LCD) device includes a LCD panel and a backlight module. As the LCD panel is not self-illuminating, the backlight module is adopted to provide light source for displaying image. Consequently, the quality of light source provided by the backlight module has direct influence on the quality of displayed image.

The backlight modules can be divided into a direct-type backlight module and an edge-type backlight module. The edge-type backlight module is thinner than the direct-type backlight module, and has thus been used extensively in thin LCD devices. In a typical edge-type backlight module, light beams entering a light guiding plate from a light incidence surface of the light guiding plate would perform total internal reflection. Properly microstructures are disposed to destroy the total internal reflection, so that the light beams may homogenously emerge from a light emergence surface of the light guiding plate. A reflective sheet is disposed on a bottom surface of the light guiding plate for reflecting light beams emerged from the bottom surface back to the light guiding plate. The reflective sheet is adhered to the bottom surface of the light guiding plate by an adhesive. However, the presence of adhesive has been known to reduce the performance of total internal reflection at the bottom surface of the light guiding plate, thus leading to reduction in light utilization efficiency.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention provides a surface light source module for improving light utilization efficiency.

The invention provides a surface light source module for improving light utilization efficiency and achieving thinner.

Other objectives and advantages of the invention may be further comprehended through the technical features disclosed herein.

In order to achieve one or a portion of or all of the objects or other objects, an embodiment of the invention provides a surface light source module including a light guiding plate, a reflective sheet, an adhesive, and a light emitting assembly. The light guiding plate includes a light incidence surface and a bottom surface adjacent to the light incidence surface. The reflective sheet is disposed on the bottom surface. The adhesive is adhered between the bottom surface and the reflective sheet. The light emitting assembly is disposed alongside of the light incident surface. A refractive index of the adhesive is N1, a refractive index of the light guiding plate is N2, and 63%≦N1/N2≦95%. The light emitting assembly includes a plurality of light emitting elements, and a distribution curve of luminous intensity of each of the light emitting elements satisfies following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of the total lumen of the light emitting element.

In order to achieve one or a portion of or all of the objects or other objects, another embodiment of the invention provides a surface light source module including a light guiding plate, a back plate, an adhesive, and a light emitting assembly. The light guiding plate includes a light incidence surface and a bottom surface adjacent to the light incidence surface. The back plate supports the light guiding plate, wherein the back plate includes a bottom wall for supporting the light guiding plate and the bottom wall includes a reflective surface facing the light guiding plate. The adhesive is adhered between the bottom surface and the reflective surface, wherein a refractive index of the adhesive is N1, a refractive index of the light guiding plate is N2, and 63%≦N1/N2≦95%. The light emitting assembly is disposed alongside of the light incident surface, wherein the light emitting assembly includes a plurality of light emitting elements. A distribution curve of luminous intensity of each of the light emitting elements satisfies following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of the total lumen of the light emitting element.

The surface light source modules of the embodiments of the invention configure the ratio of refractive indices between adhesive and light guiding plate and utilize light emitting elements with specific distribution curve of luminous intensity to effectively prevent destruction of total internal reflection in the light guiding plate by adhesives and thus to improve light utilization efficiency. Additionally, as the back plate of the surface light source module of an embodiment includes a reflective surface, utilization of a reflective sheet commonly known in the art may be omitted, so as to provide a thinner surface light source module.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a schematic illustration of a surface light source module of an embodiment of the invention;

FIG. 2 is a distribution curve of luminous intensity of a light emitting element in an embodiment of the invention;

FIG. 3 is a schematic illustration of a surface light source module of another embodiment of the invention;

FIG. 4 is a schematic illustration of a surface light source module of still another embodiment of the invention;

FIG. 5 is a schematic illustration of a surface light source module of yet another embodiment of the invention; and

FIG. 6 is a schematic illustration of a surface light source module of still yet another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

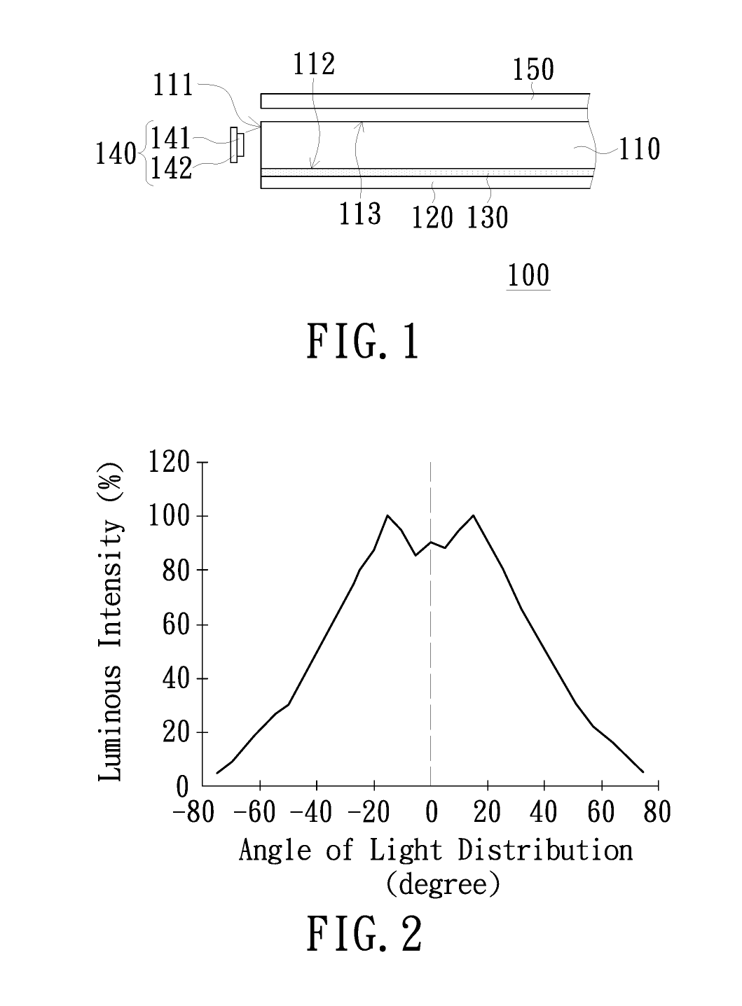

The surface light source module of the invention may be, but not limited to, used in a non-self-luminous display device such as a liquid crystal display device for providing a display light source. Referring to FIG. 1, which illustrates a surface light source module of an embodiment of the invention. As shown in FIG. 1, a surface light source module 100 of this embodiment includes a light guiding plate 110, a reflective sheet 120, an adhesive 130, and a light emitting assembly 140. The light guiding plate 110 includes a light incidence surface 111, a bottom surface 112 adjacent to the light incidence surface 111, and a light emergence surface 113 opposite to the bottom surface 112. The light incidence surface 111 is connected to and between the bottom surface 112 and the light emergence surface 113. The reflective sheet 120 is disposed on the bottom surface 112. The adhesive 130 is adhered between the bottom surface 112 and the reflective sheet 120. The light emitting assembly 140 is disposed alongside of the light incident surface 111. The light emitting assembly 140 includes a plurality of light emitting elements 141, and FIG. 1 only illustrates one light emitting element 141 for exemplary purposes. The light emitting elements 141 are arranged along the light incidence surface 111, so as to provide light beams (not shown) into the light guiding plate 110 via the light incidence surface 111.

In this embodiment, the light emitting assembly 140 may further include a circuit board 142. The light emitting element 141 is disposed on and electrically coupled to the circuit board 142, so that light emission of the light emitting element 141 is driven by the circuit board 142. The light beams entering the light guiding plate 110 may perform total internal reflection between the light emergence surface 113 and the bottom surface 112 of the light guiding plate 110, thus transmitting away from the light emitting element 141. Either or both of the light emergence surface 113 and the bottom surface 112 may be disposed with microstructures (dots for example, not shown) to destroy the total internal reflection, so that the light beams may emerge from the light emergence surface 113 and the bottom surface 112. The shape of the microstructure in the invention is not limited to any particular shape. The light beams emergent from the bottom surface 112 may be reflected back to the light guiding plate 110 by the reflective sheet 120 and emerge from the light emergence surface 113. In this way, the light beams may be reutilized to avoid light leakage. The reflective sheet 120 may be, but not limited to, a white reflective sheet or a silver reflective sheet. Additionally, distribution of the microstructures may be designed according to specific needs. For example, in an embodiment, the intensity of distribution of the microstructures may increase from a side close to the light emitting element 140 towards a side away from the light emitting element 140. Moreover, the surface light source module 100 may further include an optical film 150 disposed above the light emergence surface 113 of the light guiding plate 110, so as to homogenize the light beams and adjust light paths. The optical film 150 may be one or a plurality of diffusion film or brightness enhancement film (BEF), and FIG. 1 illustrates only one optical film 150 for exemplary purposes. However, the invention is not limited thereto.

In this embodiment, as the reflective sheet 120 is adhered to the bottom surface 112 of the light guiding plate 110 by the adhesive 130, whether the light beams transmitted to the bottom surface 112 of the light guiding plate 110 could perform total internal reflection are associated with refractive indices of the light guiding plate 110 and the adhesive 130 and incident angles of the light beams according to the Snell's Law. The light beams passing through the bottom surface 112 of the light guiding plate 110, due to the incident angle of the light beam (such as the angle of light beam incidence to the light incidence surface 111 being too large or the angle of light beam incidence to the bottom surface 112 being too small) but not to the microstructure, and further passing through the adhesive 130 may still lose when being reflected by the reflective sheet 120, even if the majority of the light beams are reflected back to the light guiding plate 110 by the reflective sheet 120. To ensure total internal reflection of the light beams in the light guiding plate 110, this embodiment defines the refractive indices of the adhesive 130 and light guiding plate 110 and the distribution curve of luminous intensity of each of the light emitting elements 141. More specifically, the refractive index of the adhesive 130 is N1, the refractive index of the light guiding plate is N2, and refractive indices N1 and N2 accord with 63%≦N1/N2≦95%. Referring to FIG. 2, which illustrates a distribution curve of luminous intensity of the light emitting element 141 in an embodiment of the invention. The distribution curve of luminous intensity of each of the light emitting elements 141 satisfies the following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of the total lumen of the light emitting element. The distribution curve of luminous intensity of the light emitting element 141 corresponds to the curve of distribution of luminous intensity of light beams emitted by the light emitting element 141. As shown in FIG. 2, the x-axis represents the angle of light distribution (degree) and y-axis represents the luminous intensity (%); the curve is drawn away from the central axis (degree of light distribution=0) to describe the luminous intensity. It is to be understood that the invention is not limited to the exemplary illustration in FIG. 2.

Referring again to FIG. 1. Configuring the correlation between the refractive index N1 of the adhesive 130 and the refractive index N2 of the light guiding plate 110 may determine a critical angle, and configuring the distribution curve of luminous intensity of each of the light emitting elements 141 may direct the incidence of the majority of light beams to the bottom surface 112 of the light guiding plate 110 at an angle larger than the critical angle, so as to perform total internal reflection. Therefore, when the refractive indices N1 and N2 and the distribution curve of luminous intensity of each of the light emitting elements 141 satisfy the aforementioned conditions, the reduction in performance of total internal reflection at the bottom surface 112 of the light guiding plate 110 due to the presence of the adhesive 130 can be effectively improved, thus enhancing the efficiency of light utilization.

In this embodiment, the material of the light guiding plate 110 may be polymethylmethacrylate (PMMA), polycarbonate (PC), or glass. The refractive indices of PMMA, PC, and glass are about 1.49, 1.585, and 1.52, respectively. Additionally, the refractive index of the adhesive 130 may range, but not limited to, between 1.3 and 1.5, and be 1.4 for example. Cost of the adhesive 130 may be too high if the refractive index of the adhesive 130 is lower than 1.3. Therefore, this embodiment limits N1/N2 to be greater than or equal to 63%, so that the conditions can be satisfy without having to choose adhesives 130 with particularly low refractive indices. If the refractive index is higher than 1.5, the condition N1/N2≦95% would be difficult to achieve. Furthermore, the adhesive 130 may be solid optically clear adhesive (OCA) tape or solidified from liquid adhesives. The refractive index of OCA is about 1.45, and the refractive index of liquid adhesives ranges between 1.315 and 1.38. Liquid adhesives may include Norland NOA1315 (refractive index about 1.315), NOA132 (refractive index about 1.32), NOA133 (refractive index about 1.33), NOA1327 (refractive index about 1.327), NOA1328 (refractive index about 1.328), NOA13685 (refractive index about 1.3685), NOA1375 (refractive index about 1.375), and NOA138 (refractive index about 1.38). It is to be understood that the materials of the light guiding plate 110 and the adhesive 130 as listed above are merely exemplary and are not meant to limit the invention.

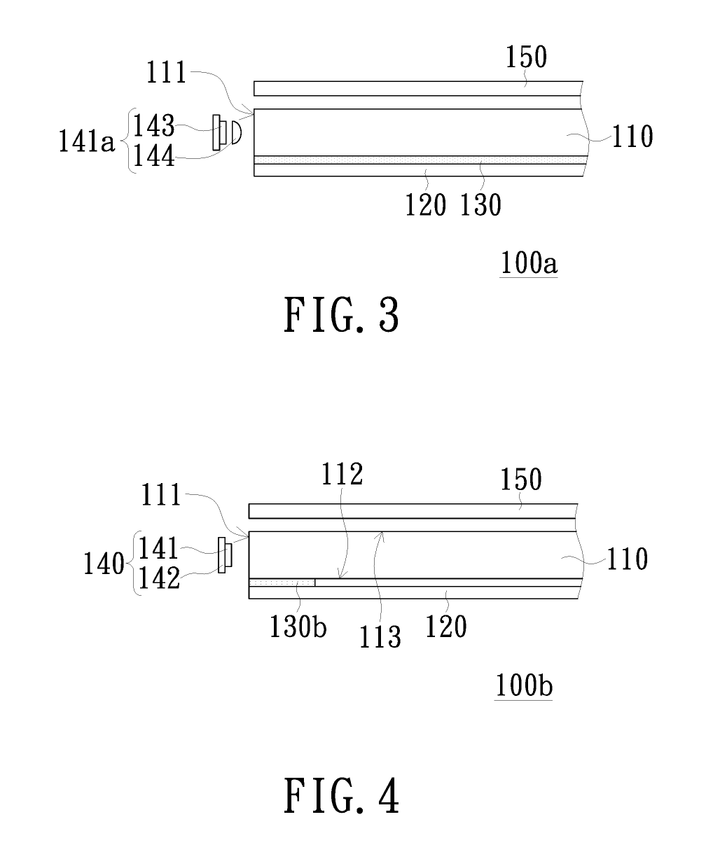

In FIG. 1, each of the light emitting elements 141 may be, but not limited to, a light emitting element package structure, such as light emitting diode (LED) package structure. The distance between the light emitting element 141 (or the light emitting surface of the light emitting element 141, not shown) and the light incidence surface 111 of the light guiding plate 110 may range between 0.3 mm and 0.5 mm. LED package structure may include a light emitting chip (not shown) and a first lens (not shown) for adjusting the type of light. However, if the curve of light distribution of the LED package structure could not satisfy the aforementioned conditions, an additional second lens may be disposed for adjusting the curve of light distribution. Referring to FIG. 3, which illustrates a surface light source module of another embodiment of the invention. As shown in FIG. 3, in the surface light source module 100a, each of the light emitting elements 141a includes a light emitting element package structure 143 and a second lens 144 disposed between the light emitting element package structure 143 and the light incidence surface 111 of the light guiding plate 110. The second lens 144 is not packed with the light emitting element package structure 143, but is in a proper distance away from the light emitting element package structure 143. Additionally, in another embodiment, each of the light emitting elements 141 may be a laser diode package structure (LD structure) capable of providing a light distribution curve that satisfies the aforementioned conditions.

Referring again to FIG. 1, the adhesive 130 may adhere to the entire bottom surface 112 of the light guiding plate 110. The adhesive 130 may entirely cover the bottom surface 112 or form a plurality of adhesive blocks covering the bottom surface 112, but is not limited thereto. However, if taking production efficiency and costs into consideration, the adhesive 130 may partially adhere to areas close to the light emitting assembly 140 on the bottom surface 112 of the light guiding plate 110. Referring to FIG. 4, which illustrates a surface light source module of still another embodiment of the invention. As shown in FIG. 4, in the surface light source module 100b, the location of the adhesive 130b adhered to the bottom surface 112 of the light guiding plate 110 is close to the light emitting assembly 140. In an embodiment, the total area of the bottom surface 112 adhered to the adhesive 130 may be larger than or equal to 10% of the total area of the bottom surface 112. The total area of the bottom surface 112 adhered to the adhesive 130 corresponds to the total area of the adhesive 130 distributed on and parallel to the bottom surface 112. Therefore, the adhesive 130 entirely covering the bottom surface 112, partially adhering to the bottom surface 112, or forming a plurality of adhesive blocks on the bottom surface 112 would all satisfy the aforementioned condition.

On the light guiding plate 110, the closer an area is to the light emitting assembly 140, the stronger the luminous power it exhibits. Therefore, partial adherence of the adhesive 130 to the area close to the light emitting assembly 140 on the bottom surface 112 of the light guiding plate 110 would be sufficient to effectively prevent light loss and apparent bright rays occurred in areas close to the light emitting assembly 140 on the light emergence surface 113 of the light guiding plate 110.

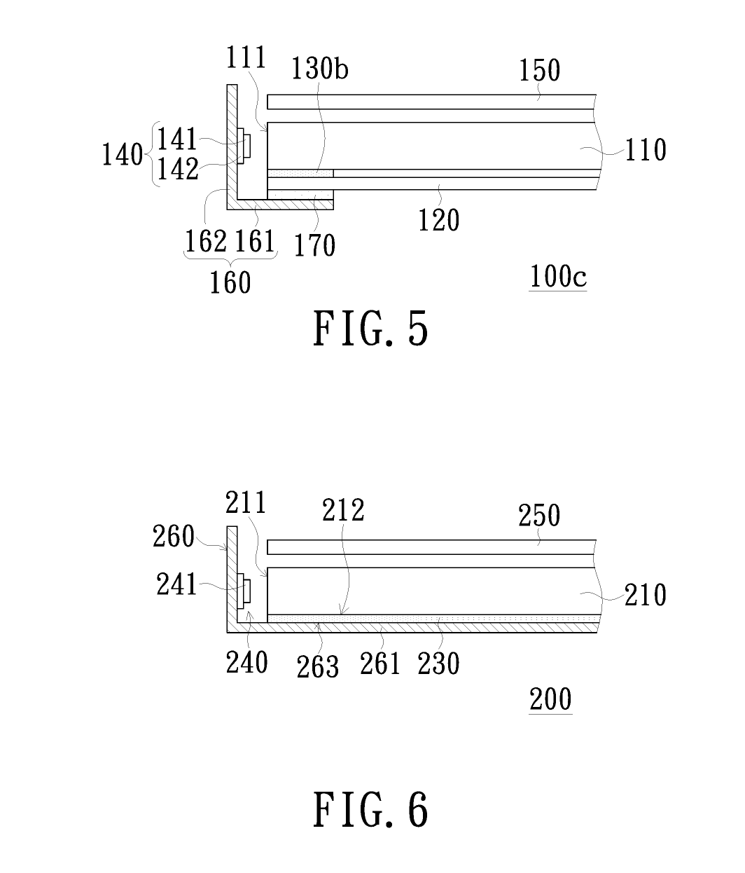

Referring to FIG. 5, which illustrates a surface light source module of yet another embodiment of the invention. As shown in FIG. 5, the surface light source module 100c is similar to the surface light source module 100b in FIG. 4. The differences are that the surface light source module 100c further includes a back plate 160, which supports the reflective sheet 120 and the reflective sheet 120 is disposed between the adhesive 130b and the back plate 160. The back plate 160 of the invention includes a bottom wall 161 located beneath the light emitting assembly 140 and the light incidence surface 111 of the light guiding plate 110, and the location of adherence of the adhesive 130b corresponds to the bottom wall 161. In an embodiment, the orthogonal projection of the adhesive 130b on the bottom wall 161 locates within, and not outside of, the range of the bottom wall 161. Additionally, the back plate 160 may be made of materials with better heat dissipation capacity, such as aluminum, aluminum alloy, and other metals. The surface light source module 100c further includes an adhesive 170 for adhesion of the back plate 160 with the reflective sheet 120. The stickiness of the adhesive 170 may be stronger than that of the adhesive 130. In another embodiment, the back plate 160 and the reflective sheet 120 may be fixed by welding or screw locking if the reflective sheet 120 is made of metal. Furthermore, the side wall 162 of the back plate 160 may support the light emitting assembly 140. Moreover, the aforementioned surface light source modules 100 and 100a may also include the back plate 160.

Referring to FIG. 6, which illustrates a surface light source module of still yet another embodiment of the invention. As shown in FIG. 6, the surface light source module 200 of this embodiment includes a light guiding plate 210, an adhesive 230, a light emitting assembly 240, and a back plate 260. The light guiding plate 210 includes a light incidence surface 211 and a bottom surface 212 adjacent to the light incidence surface 211. The back plate 260 supports the light guiding plate 210. The back plate 260 includes a bottom wall 261 for supporting the light guiding plate 210, and the bottom wall 261 includes a reflective surface 263 facing the light guiding plate 210. The adhesive 230 is adhered between the bottom surface 212 and the reflective surface 263. The surface light source module 200 of this embodiment may further includes an optical film 250 disposed above the light guiding plate 210. In this embodiment, the light guiding plate 210, the adhesive 230, the light emitting assembly 240, and the optical film 250 are similar to the aforementioned light guiding plate 110, the adhesive 130, the light emitting assembly 140, and the optical film 150, respectively. In other words, the refractive index N1 of adhesive 230 and the refractive index N2 of the light guiding plate 210 accord with 63%≦N1/N2≦95%. The distribution curve of luminous intensity of each of the light emitting elements 241 of the light emitting assembly 240 also satisfies the following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of a total lumen of the light emitting element. For details on the light guiding plate 210, the adhesive 230, the light emitting assembly 240, and the optical film 250, please refer to above descriptions on the light guiding plate 110, the adhesive 130, the light emitting assembly 140, and the optical film 150, repetitious details are thus not provided herein. Additionally, the light emitting element 241 may be replaced with light emitting elements 141a shown in FIG. 3, a light emitting element package structure and a second lens disposed between the light emitting element package structure and the light incidence surface 211.

The surface light source module 200 of this embodiment also satisfies the aforementioned conditions and thus exhibits excellent light utilization efficiency as well. Additionally, as the back plate 260 includes a reflective surface 263 for reflecting lights, the reflective sheet 120 in the aforementioned embodiments may be omitted. In this way, overall thickness of the surface light source module 200 may be reduced, thus satisfying the trend of thinner. The reflective surface 263 of the back plate 260 of this embodiment may be, but not limited to, a white reflective surface or a silver reflective surface.

In sum, the embodiments of the invention may achieve at least one of the following advantages or effects. The surface light source modules of the embodiments of the invention configure the ratio of refractive indices between adhesive and light guiding plate and utilize light emitting elements with specific distribution curve of luminous intensity to effectively prevent destruction of total internal reflection in the light guiding plate by adhesives and thus to improve light utilization efficiency. Additionally, as the back plate of the surface light source module of an embodiment includes a reflective surface, utilization of a reflective sheet commonly known in the art may be omitted, so as to provide a thinner surface light source module.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A surface light source module, comprising:
a light guiding plate, comprising a light incidence surface and a bottom surface adjacent to the light incidence surface;
a reflective sheet, disposed on the bottom surface;
an adhesive, adhered between the bottom surface and the reflective sheet, wherein a refractive index of the adhesive is N1, a refractive index of the light guiding plate is N2, and 63%≦N1/N2≦95%; and
a light emitting assembly, disposed alongside of the light incident surface, wherein the light emitting assembly comprises a plurality of light emitting elements and a distribution curve of luminous intensity of each of the light emitting elements satisfies following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of a total lumen of the light emitting element.

2. The surface light source module of claim 1, wherein the refractive index of the adhesive ranges between 1.3 and 1.5.

3. The surface light source module of claim 1, wherein a total area of the bottom surface of the light guiding plate adhered to the adhesive is larger than or equals to 10% of the total area of the bottom surface.

4. The surface light source module of claim 1, wherein the adhesive is partially adhered to the bottom surface of the light guiding plate and a location of adherence of the adhesive at the bottom surface is adjacent to the light emitting assembly.

5. The surface light source module of claim 4, further comprising:
a back plate, supporting the reflective sheet, and the reflective sheet disposed between the adhesive and the back plate.

6. The surface light source module of claim 1, wherein each of the light emitting elements comprises a light emitting element package structure.

7. The surface light source module of claim 6, wherein each of the light emitting elements further comprises a second lens disposed between the light emitting element package structure and the light incidence surface.

8. A surface light source module, comprising:
a light guiding plate, comprising a light incidence surface and a bottom surface adjacent to the light incidence surface;
a back plate, supporting the light guiding plate, wherein the back plate comprises a bottom wall for supporting the light guiding plate and the bottom wall comprises a reflective surface facing the light guiding plate;
an adhesive, adhered between the bottom surface and the reflective surface, wherein a refractive index of the adhesive is N1, a refractive index of the light guiding plate is N2, and 63%≦N1/N2≦95%; and
a light emitting assembly, disposed alongside of the light incident surface, wherein the light emitting assembly comprises a plurality of light emitting elements and a distribution curve of luminous intensity of each of the light emitting elements satisfies following conditions: (1) an absolute value of a distribution angle at 50% of luminous intensity is smaller than or equal to 55°; and (2) a sum of luminous energy at the absolute value of the distribution angle of greater than 70° is smaller than or equal to 10% of a total lumen of the light emitting element.

9. The surface light source module of claim 8, wherein the refractive index of the adhesive ranges between 1.3 and 1.5.

10. The surface light source module of claim 8, wherein the reflective surface of the back plate is a white reflective surface or a silver reflective surface.
